(19) United States
(12) Patent Application Publication
(10) Pub. No.: US 2011/0181072 A1
(43) Pub. Date: Jul. 28, 2011

(54) AERODYNAMIC WING APPARATUS FOR A VEHICLE, TRAILER OR CARGO BOX, VEHICLE OR TRAILER INCORPORATING SAME, AND METHOD OF USING SAME

(76) Inventor: Fred Gene KEMPSTER, Troy, MI (US)

(21) Appl. No.: 13/015,012

(22) Filed: Jan. 27, 2011

Related U.S. Application Data
(60) Provisional application No. 61/299,230, filed on Jan. 28, 2010.

(51) Int. Cl. B62D 35/00

(52) U.S. Cl. 296/180.5

(57) ABSTRACT

An aerodynamic wing apparatus for mounting on a top panel portion of a vehicle such as a car, a truck cargo box or trailer portion of a tractor-trailer vehicle, in order to improve the aerodynamic movement of the vehicle through the air, provide lift to the vehicle in order to reduce the effective weight thereof, improve fuel economy of the vehicle, and reduce carbon emissions. The wing apparatus includes a main wing body having an airfoil-shaped cross-section, with a rounded leading edge and a substantially sharp trailing edge. The main wing body is adjustably movable to account for changing ambient conditions. The wing apparatus also includes a support frame for mounting the main wing body to a vehicle so as to be spaced away from a top panel portion thereof. A control system may also be provided to control operation of the apparatus, and a method of operation is described.

### CROSS-REFERENCE TO RELATED APPLICATIONS

The present application claims priority under 35 USC §119 based on U.S. provisional application No. 61/299,230, filed on Jan. 28, 2010. The entire subject matter of this priority document, including written specification and drawings, is incorporated by reference herein.

### BACKGROUND OF THE INVENTION

1. Field of the invention

The present invention relates to vehicles and trailers, including truck trailers and box trucks of the type used to transport cargo, and to methods and apparatus for improving aerodynamics and fuel economy of such vehicles and trailers. More particularly, the present invention relates to an aerodynamic wing apparatus for placement on a top panel portion of a vehicle or trailer, to a vehicle or trailer having such a wing apparatus mounted thereon, and to a method of using the wing apparatus on a vehicle, trailer or cargo box.

2. Description of the Background Art

A number of different devices are known for making truck trailers more aerodynamic. Examples of some of the known devices include those disclosed in U.S. Pat. No. 4,789,117 to Paterson et al., U.S. Pat. No. 6,742,616 to Leban and U.S. Pat. No. 7,641,262 to Nussbaum.

Although the known devices have some utility for their intended purposes, a need still exists in the art for an apparatus for improving the aerodynamic performance of a vehicle or trailer, as well as for a vehicle or trailer having improved aerodynamic performance to provide improved fuel economy and reduced carbon emissions, resulting in a “Green” product. A need also exists for a method of using such an apparatus on a top panel portion of a vehicle, truck trailer or truck cargo box.

### SUMMARY OF THE INVENTION

The present invention provides an aerodynamic wing apparatus for operatively mounting on a top panel portion of a vehicle such as, e.g., on a truck cargo box or a trailer portion of a tractor-trailer vehicle, in order to improve the aerodynamic movement of the vehicle, trailer or cargo box through the air, to provide lift to the trailer or cargo box to reduce the effective weight thereof, to improve fuel economy of the vehicle, and to reduce carbon emissions.

The wing apparatus includes a main wing body having an airfoil-shaped cross-section, with a rounded leading edge and a substantially sharp trailing edge. The apparatus hereof could also be adapted for use on a passenger car.

The wing apparatus according to the depicted embodiment also includes a support frame for mounting the main wing body to the top panel portion of a vehicle or trailer. The support frame may include two side struts disposed at opposite sides of the trailer. The side struts may be placed inside of the vehicle or trailer, may be attached to the outside of the vehicle or trailer, or a reinforced trailer may be provided and a smaller support frame may be attached to a roof portion of the vehicle or trailer.

The side struts provide a spacer for spacing the main wing body upwardly away from an upper roof surface of the top panel portion, in order to ensure that air may flow between the main wing body and the vehicle or trailer.

A control system for the apparatus includes a wing control module, a motor, and a plurality of sensors. During operation, the wing control module will evaluate data input from a wing angle sensor as well as other environmental sensors, and the wing control module will continually adjust the angular position of the main wing body during use, in order to provide the best amount of lift for ambient conditions, and also to assist during braking operations by selectively providing drag rather than lift.

Optionally, the wing may be made movable between a stored position in which it is lowered to contact the upper roof surface of the top panel portion, and a deployed position in which it is raised up to be spaced away from the upper roof surface.

It is believed that when the vehicle, which may be a tractor-trailer equipped with the aerodynamic wing apparatus hereof is moving down a road during vehicle operation, air flow past the main wing body will create a “lift” effect similar to that which occurs when an airplane is moving down a runway during takeoff, and that this “lift” effect will reduce the effective weight of the trailer experienced as load on the vehicle engine, leading to improved efficiencies, better gas mileage, and reduced carbon emissions, resulting in a “Green” product.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a perspective view of a box truck having an aerodynamic wing apparatus according to a first illustrated embodiment hereof mounted on the cargo box thereof.

FIG. 2 is a side plan view of tractor-trailer assembly having an aerodynamic wing apparatus according to a second illustrated embodiment hereof mounted on the trailer.

FIG. 3A is a top plan view of the tractor-trailer apparatus of FIG. 2, showing a wing apparatus according to a first embodiment hereof.

FIG. 3B is a top plan view of the tractor-trailer apparatus of FIGS. 2, showing a wing apparatus according to a second embodiment hereof.

FIG. 4A is a detail side plan view of the wing apparatus of FIG. 2 according to a first embodiment hereof, showing an adjustment mechanism for variably adjusting the position of the main wing member relative to the trailer.

FIG. 4B is a detail side plan view of the wing apparatus of FIG. 2 according to a second embodiment hereof, showing an adjustment mechanism for variably adjusting the position of the main wing member relative to the trailer, and also showing an optional winglet.

FIG. 5 is a simplified schematic diagram showing an electronic control system for controlling operation of the wing apparatus hereof, including a number of sensors and an electronic wing control module.

### DETAILED DESCRIPTION OF THE PREFERRED EMBODIMENTS

A number of selected illustrative embodiments of the invention will now be described, with reference to the accompanying drawings. The best mode currently contemplated for carrying out the present invention is included in the following description. Throughout the present specification, relative positional terms like ‘upper’, ‘lower’, ‘front’, ‘rear’, ‘top’, ‘bottom’, ‘horizontal’, ‘vertical’, and the like are used to refer to the orientation of the apparatus as shown in the drawings. These terms are used in an illustrative sense to describe the depicted embodiments, and are not meant to limit the invention to the described orientation. It will be understood that the depicted apparatus may be placed at an orientation different from that shown in the drawings, such as inverted 180 degrees or transverse to that shown, and in such a case, the above-identified relative positional terms will no longer be accurate.

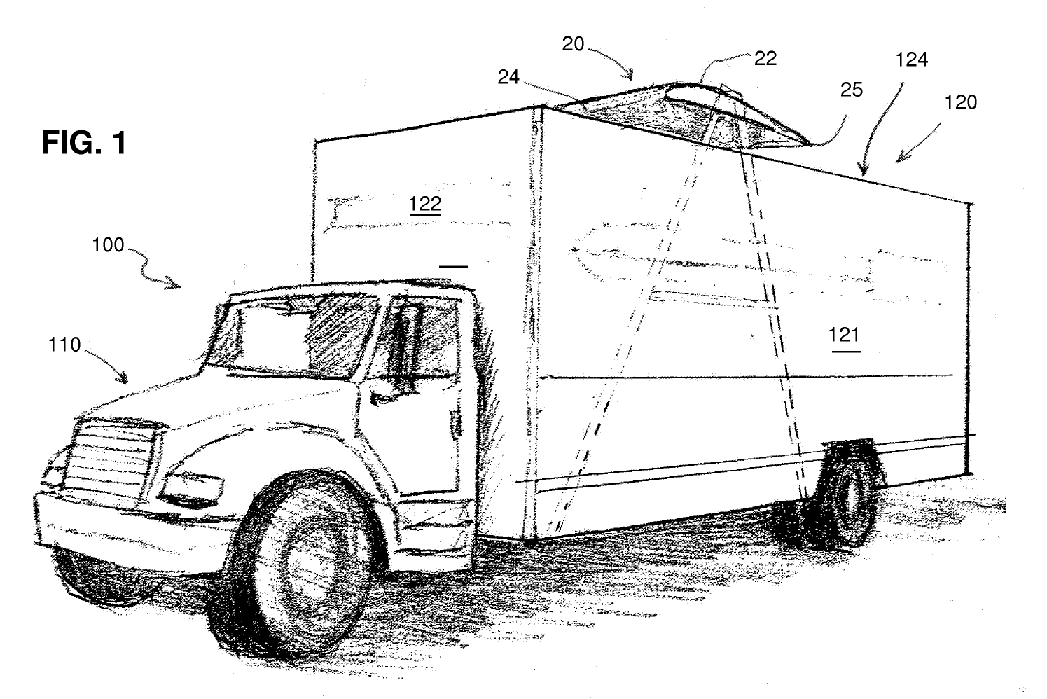

Referring now to FIG. 1 of the drawings, a box truck according to a first embodiment of the invention is shown generally at 100. The box truck 100 includes a conventional cab 110, including a frame (not shown) with an engine assembly mounted thereon. The box truck 100 also includes a cargo box 120 attached to the frame of the cab. The cargo box 120 includes a side wall 121, a front wall 122 and a roof 124. The cargo box 120 has a hollow interior formed therein for storing and transporting cargo.

The cargo box 120 according to the depicted embodiment also has an aerodynamic wing apparatus 20 operatively mounted thereon, according to a selected illustrative embodiment of the present invention. The wing apparatus 20 includes a main wing body 22 having an airfoil-shaped cross-section. The main wing body 22 has a rounded leading edge 24 and a substantially sharp trailing edge 25. The main wing body 22 may be placed at, or proximate a center of gravity of the cargo box 120. As used herein, the term “chord length” refers to the distance between the trailing edge and the leading edge of the main wing body.

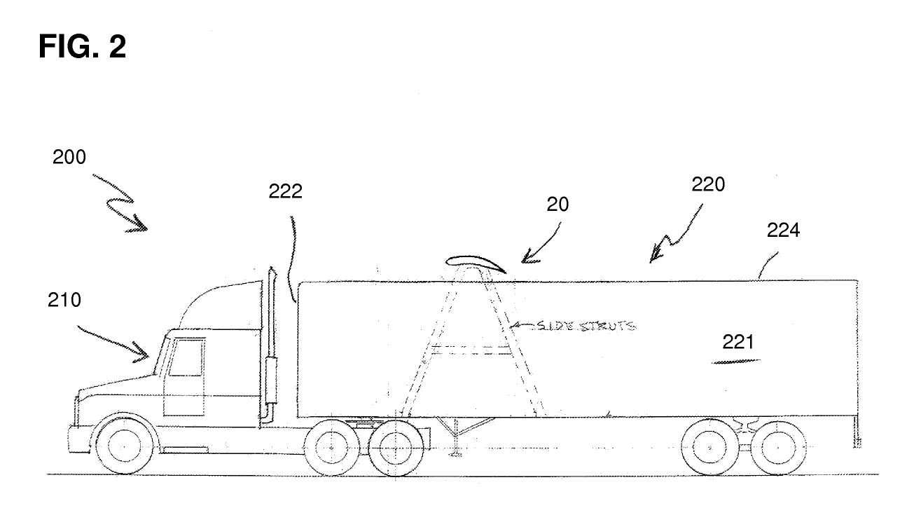

Referring now to FIG. 2 of the drawings, a tractor-trailer apparatus according to a second embodiment of the invention is shown generally at 200. The tractor-trailer 200 includes a conventional tractor 210, including a frame 212 with a cab and an engine assembly mounted thereon. The tractor-trailer 200 also includes a trailer 220 pivotally attached to the frame 212 of the tractor 210. The trailer 220 includes a side wall 221, a front wall 222 and a roof 224. The trailer 220 has a hollow interior formed therein for storing and transporting cargo.

The trailer 220 according to the depicted embodiment also has an aerodynamic wing apparatus 20 according to the present invention operatively mounted thereon. The wing apparatus 20 includes a main wing body 22 having an airfoil-shaped cross-section. The main wing body 22 has a rounded leading edge 24 and a substantially sharp trailing edge 25. The main wing body 22 may be placed at, or proximate a center of gravity of the trailer 220. The main wing body 22 is generally configured to be either the same width as the roof of the vehicle or trailer on which it is mounted, or a slightly smaller width than the vehicle roof or trailer. The dimensions of the wing apparatus 20 are selected to provide an optimal amount of lift for operator convenience and improved gas mileage.

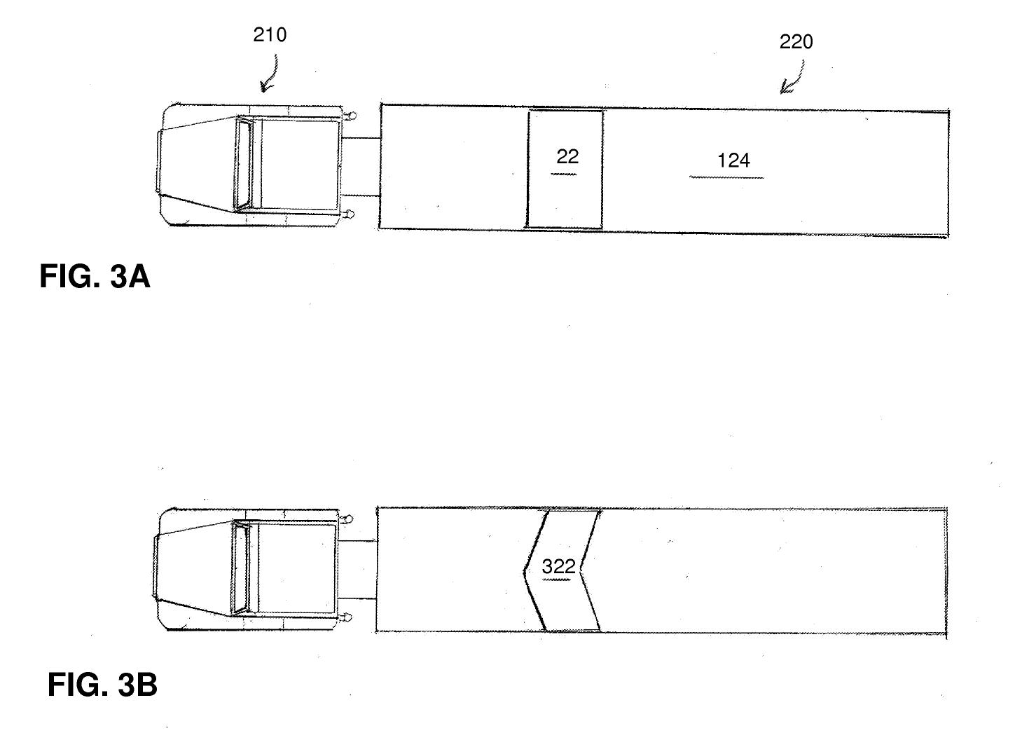

In one exemplary embodiment, the main wing body 22 is configured to that the chord length thereof is selected to be at least one-quarter of the side-to-side width of the vehicle body or trailer on which the wing body is mounted. This is so that a sufficient amount of lift can be generated. In the examples depicted in FIGS. 3A-3B, the chord length is at least one third of the side-to-side width of the trailer on which the main wing body 22 is mounted.

The main wing body 22 should be made strong and durable enough to handle continued exposure to changing ambient weather conditions as well as traveling winds in an outdoor environment, where such traveling winds may be in a range of different effective wind speeds.

The main wing body 22 may be formed from reinforced metal materials mounted on a suitable support frame. Alternatively, the main wing body 22 may be formed from composite materials such as carbon fiber-reinforced composites. Fiberglass may also be used as a material for the main wing body 22.

The wing apparatus 20 hereof could also be reduced in size and adapted for use on a passenger car such as a sport-utility vehicle (SUV), station wagon or sedan.

Referring now to FIGS. 3A-3B, it will be seen that the main wing body 22 may have a substantially rectangular outline shape as viewed from a top plan view thereof, as shown in FIG. 3A.

Alternatively, if desired, in a modified embodiment, the main wing body 322 may have a substantially chevron-shaped outline as viewed from a top plan view thereof, as shown in FIG. 3B. As used herein, the term “chevron-shaped” means having a widened V-shape, substantially as shown in FIG. 3B. Other shapes which may be used for the main wing body include a crescent shape, a shape resembling a symmetrical boomerang, an oval, a C-shape, or a triangular delta wing shape.

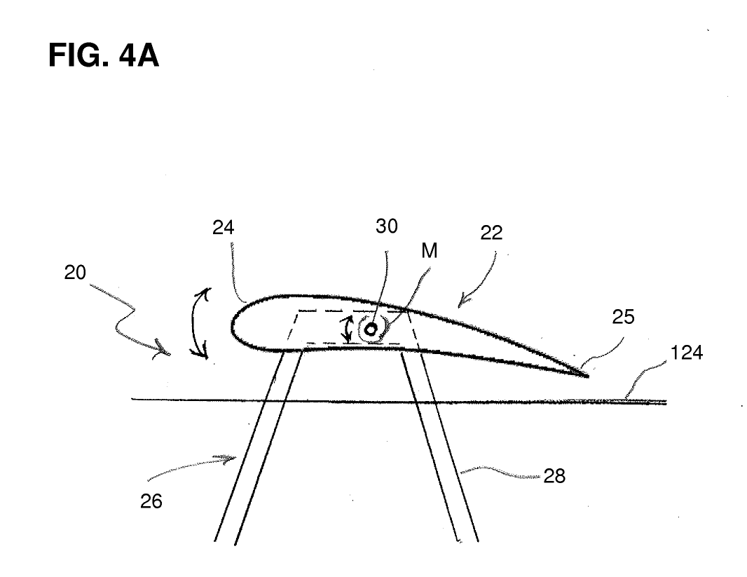

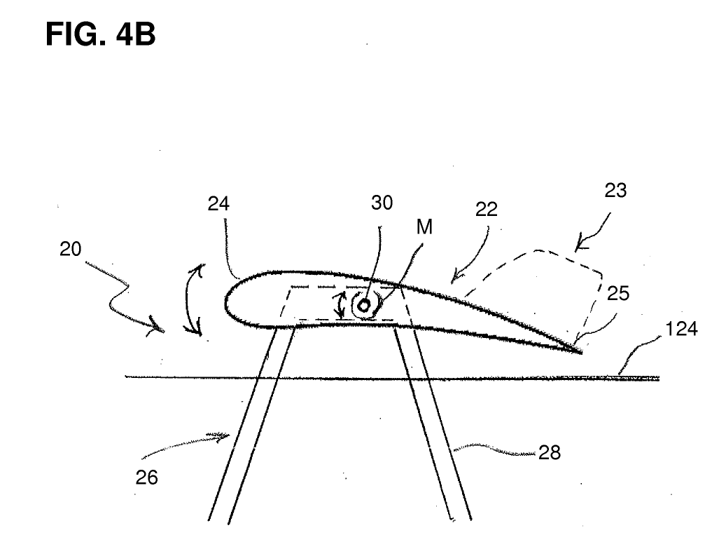

Optionally, if desired, the main wing body 22 may be provided with substantially vertical ‘winglets’ or wing tips at the outer end portions thereof, similar to those used on the wing tips of commercial airlines, in order to further improve gas mileage. An optional winglet 23 is shown in phantom outline in FIG. 4B.

In addition, if desired, the main wing body may be provided with hydraulically-controlled wing flaps therein, similar to those used on the wings of commercial airlines, in order to provide better adjustment and control thereof.

The wing apparatus 20 according to the depicted embodiment also includes a support frame 26 for mounting the main wing body 22 to the truck cargo box 120 or trailer 220. The support frame 26 includes two side struts 28 configured to be placed at opposite sides of the truck cargo box 120 or trailer 220. The side struts 28 may be placed inside the truck cargo box 120 or trailer 220, or may be attached to the outside of the cargo box or trailer.

The side struts 28 provide a spacer for spacing the main wing body 22 upwardly away from an upper roof surface 124 or 224 of the truck cargo box 120 or trailer 220, respectively, in order to ensure that air may flow between the main wing body 22 and the roof 124 or 224 of the truck cargo box 120 or trailer 220, respectively.

Alternatively, if the truck cargo box 120 or trailer 220 is sufficiently reinforced, the support frame may be reduced in size and attached to the roof 124 or 224 of the truck cargo box 120 or trailer 220, respectively.

The wing apparatus includes a pair of pivotally movable connection members 30 disposed on either side of the main wing body 22, for interconnecting the main wing body and the respective side struts 28. One or both of the connection members 30 may include a cylindrical shaft 32 which may be selectively rotated by a motor M, while the angular position of the main wing body 22 is being carefully controlled and monitored by a control system 50.

Optionally, the main wing body 22 may be made movable between a stored position in which it is lowered to contact the upper roof surface 124, and a deployed position in which the main wing body is raised up to be spaced away from the upper roof surface 124.

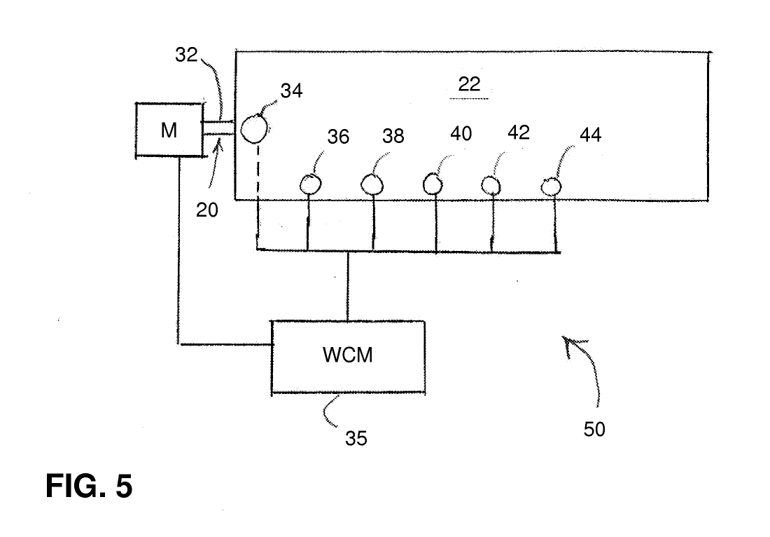

Referring now to FIG. 5, the control system 50 includes a wing angle sensor 34 and a plurality of other environmental sensors 36, 38, 40, 42 and 44. These environmental sensors 36, 38, 40, 42 and 44 may include a pressure sensor, an effective wind speed sensor, a wind direction sensor, a temperature sensor, a vehicle tilt sensor to determine a grade on which the vehicle is traveling, and/or other environmental sensors known in the art.

The control system 50 may also include a wing control module 35, which may be provided in the tractor-trailer 100 for electronically controlling operation of the wing apparatus 20. Preferably, where used, the wing control module may either be incorporated into or in coordinated electronic communication with the powertrain control module of the tractor 110 or vehicle. Where used, the wing control module 35 may be in electronic communication with the wing angle sensor 34, which is operatively connected to the shaft 32 to read an angular position of the main wing member 22 relative to the trailer roof 124.

During operation, the wing control module 35 will evaluate the data input from the wing angle sensor 34 as well as the other environmental sensors 36, 38, 40, 42 and 44, and will continually adjust the vertical distance from the roof 124, as well as the angular position of the main wing body 22 during use, in order to provide the best amount of lift for ambient conditions.

The environmental sensors may also include a brake application sensor for sensing a condition in which pressure has been applied to the vehicle brakes. Optionally, the control system 50 may be operable to move the main wing body 22 to a modified position during a braking operation to provide drag instead of lift, in order to assist in the braking operation.

It is believed that when the tractor-trailer 100 is moving down a road during vehicle operation, air flow past the main wing body 22 will create a “lift” effect similar to that which occurs when an airplane is moving down a runway during takeoff, and that this “lift” effect will reduce the effective weight of the trailer experienced as load on the engine of the tractor 110, leading to improved efficiencies such as better gas mileage, reduced carbon emissions resulting in a “Green” product, reduced tire wear, reduced chassis and axle wear. It is also believed that widespread adoption of the present invention could reduce wear and tear on highways as a cumulative effect, if multiple cars and trucks use the inventive wing apparatus hereof.

The present invention also relates to a method of using the inventive wing apparatus 20 hereof on a vehicle or trailer. The method includes steps of sensing ambient conditions around a vehicle or trailer during operation thereof, adjusting the main wing body 22 to a first position based on the sensed ambient conditions during normal use to provide an aerodynamic lift to reduce the effective weight of the vehicle or trailer. Optionally, the method includes a step of adjusting the main wing body 22 to a second position during a braking operation to provide drag instead of lift.

Although the present invention has been described herein with respect to a limited number of presently preferred embodiments, the foregoing description is intended to be illustrative, and not restrictive. Those skilled in the art will realize that many modifications of the preferred embodiment could be made which would be operable. All such modifications, which are within the scope of the claims, are intended to be within the scope and spirit of the present invention.

What is claimed is:

1. A lift-generating apparatus for mounting on a portion of a vehicle in order to improve an aerodynamic performance of said vehicle, said apparatus comprising:
a main wing body having a substantially airfoil-shaped cross-section including an arcuate leading edge and a trailing edge which is thinner than said leading edge; and
support structure for mounting the main wing body to the vehicle so as to be situated above a top panel portion of the vehicle, said support structure including a spacer for spacing the main wing body upwardly away from an upper surface of said top panel portion.

2. The lift-generating apparatus of claim 1, wherein said support structure comprises a variably adjustable height-adjusting mechanism for selectively setting a height of a portion of said main wing body relative to the upper surface of said top panel portion.

3. The lift-generating apparatus of claim 2 wherein said height-adjusting means comprises an electric motor.

4. The lift-generating apparatus of claim 1, wherein the vehicle comprises a trailer or cargo box, and wherein said support structure comprises left and right bars which extend upwardly from the upper surface of the trailer or cargo box.

5. The lift-generating apparatus of claim 1, wherein the vehicle comprises a trailer or cargo box, and wherein said support structure comprises left and right bars which extend upwardly from a frame portion of the trailer or cargo box.

6. The lift-generating apparatus of claim 1, wherein the main wing body has a substantially rectangular outline shape as viewed from a top plan view thereof

7. The lift-generating apparatus of claim 1, wherein the main wing body has a substantially chevron-shaped outline as viewed from a top plan view thereof

8. The lift-generating apparatus of claim 1, wherein the main wing body is mounted on a trailer and is located proximate a center of gravity of the trailer.

9. The lift-generating apparatus of claim 1, wherein the main wing body is configured to that the chord length thereof is selected to be at least one-quarter of the side-to-side width of the vehicle body or trailer on which the wing body is mounted.

10. In combination, a vehicle comprising a cargo storage area having a top panel portion and a lift-generating apparatus operatively attached to said vehicle in order to improve an aerodynamic performance of said vehicle, said apparatus comprising:
a main wing body having a substantially airfoil-shaped cross-section including an arcuate leading edge and a trailing edge which is thinner than said leading edge; and
a support structure for mounting the main wing body to the vehicle so as to be situated above the top panel portion of the vehicle, said support structure including a spacer for spacing the main wing body upwardly away from an upper surface of said top panel portion.

11. The combined vehicle and lift-generating apparatus of claim 10, wherein said support structure comprises a variably adjustable height-adjusting mechanism for selectively setting a height of a portion of said main wing body relative to the upper surface of said top panel portion.

12. The combined vehicle and lift-generating apparatus of claim 11, wherein said height-adjusting means comprises an electric motor.

13. The combined vehicle and lift-generating apparatus of claim 11, wherein the vehicle comprises a trailer or cargo box, and wherein said support structure comprises left and right bars which extend upwardly from the upper surface of the trailer or cargo box.

14. The combined vehicle and lift-generating apparatus of claim 11, wherein the vehicle comprises a trailer or cargo box, and wherein said support structure comprises left and right bars which extend upwardly from a frame portion of the trailer or cargo box.

15. The combined vehicle and lift-generating apparatus of claim 11, wherein the main wing body has a substantially rectangular outline shape as viewed from a top plan view thereof

16. The combined vehicle and lift-generating apparatus of claim 11, wherein the main wing body has a substantially chevron-shaped outline as viewed from a top plan view thereof

17. The combined vehicle and lift-generating apparatus of claim 11, wherein the main wing body is mounted on a trailer and is located proximate a center of gravity of the trailer.

18. The combined vehicle and lift-generating apparatus of claim 11, wherein the main wing body is configured to that the chord length thereof is selected to be at least one-quarter of the side-to-side width of the vehicle body or trailer on which the wing body is mounted.

19. A method of operation of a vehicle or trailer having a lift-generating apparatus operatively attached thereto and situated above a roof portion thereof, said method comprising the steps of:
a) sensing ambient conditions around a main wing body of the lift-generating apparatus during operation of said vehicle or trailer; and
b) adjusting the main wing body to a first position based on the sensed ambient conditions during normal use to provide an aerodynamic lift to reduce the effective weight of the vehicle or trailer.

20. The method of claim 19, further comprising a step of adjusting the main wing body to a second position during a braking operation to provide drag instead of lift.
